(19) United States
(12) Patent Application Publication
(10) Pub. No.: US 2010/0096209 A1
(43) Pub. Date: Apr. 22, 2010

(54) Air-propelled vehicle

(76) Inventor: Mohammad Fahar Usmani, Edison, NJ (US)

Correspondence Address: Mohammad Fahar Usmani, 215 Edison Glen Terrace, Edison, NJ, 08837, US

(21) Appl. No.: 12/288,368

(22) Filed: Oct. 20, 2008

(51) Int. Cl. B60K 3/00

(52) U.S. Cl. 180/302

(57) ABSTRACT

An Air-propelled Vehicle complete with wheels mounted on axels, equipped with all appropriate steering, braking, lighting and safety mechanisms required to operate the said Air-propelled Vehicle in a safe manner and that such said Air-propelled Vehicle is propelled in both forward and reverse directions with the propulsion provided by either one or more than one air motors either unidirectional or reversible and such Air-propelled Vehicle also includes, equipment to produce the required compressed air, the storage tanks to store such compressed air, a system of hoses to allow the compressed air to be distributed amongst the various components of the Air-propelled Vehicle and a compressed air flow control mechanism capable of allowing or stopping the compressed air to enter such air motors.

### CROSS REFERENCE TO RELATED APPLICATIONS

U.S. PATENT DOCUMENTS

| | |
|---|---|
| U.S. Pat. No. 7,160,171 | Rehkemper, et al. Jan. 9, 2007 |
| U.S. Pat. No. 4,433,549 | Zappia, Feb. 28, 1984 |
| U.S. Pat. No. 4,269,280 | Rosen, May 26, 1981 |
| U.S. Pat. No. 3,931,942 | Alpert, Jan. 13, 1976 |
| U.S. Pat. No. 3,740,896 | Glass, et al. Jun. 26, 1973 |
| U.S. Pat. No. 3,789,540 | Convertine, et al. Feb. 5, 1974 |
| U.S. Pat. No. 3,936,053 | Goldfarb, et al. Feb. 3, 1976 |
| U.S. Pat. No. 4,174,587 | Morin, et al. Nov. 20, 1979 |
| U.S. Pat. No. 4,329,806 | Akiyama, et al. May 18, 1982 |
| U.S. Pat. No. 4,513,967 | Halford, et al. Apr. 30, 1985 |

### STATEMENT REGARDING FEDERALLY SPONSORED RESEARCH AND DEVELOPMENT:

Not applicable

### REFERENCE TO MICROFICHE APPENDIX

Not applicable

### BACKGROUND OF THE INVENTION

This invention evolved out of a need for a vehicle that is mainly independent of the use of conventional fossil or non-fossil fuels to propel it, instead utilizes mainly compressed air as the propellant to bring such a vehicle in motion. Since this invention will enable a vehicle to travel from one point to another by utilizing compressed air, and as such the air is freely and abundantly available, the vehicle will be able to run basically on stored compressed air energy and therefore will produce no harmful pollutants compared to vehicles running on conventional fossil or non-fossil fuels.

Previous designs involved the use of compressed air to propel vehicles but involved using a conventional engine in which the compressed air was injected into the cylinders of the conventional engine, the compressed air would push the pistons inside the cylinders of the engine and, as the pistons are mechanically connected to a camshaft, movement of the pistons produced a rotation of the camshaft, that in turn, through mechanical transmission of this motion, produce the rotary motion to turn the axel of the vehicle, that in turn, rotates the wheels of the vehicle.

The problem with using a conventional engine with the compressed air arises due to the fact that there are a number of mechanical parts within the conventional engine that are involved in converting the stored energy in the compressed air into motion of the vehicle, as a result, a lot of compressed air energy is lost in overcoming friction between various moving parts of the conventional engine.

The present invention avoids use of conventional engine, yet produces motion of a vehicle effectively by utilizing stored energy in compressed air.

### Previous Designs:

| | |
|---|---|
| U.S. Pat. No. 7,160,171 | Rehkemper, et al. Jan. 9, 2007 |
| U.S. Pat. No. 4,433,549 | Zappia, Feb. 28, 1984 |
| U.S. Pat. No. 4,269,280 | Rosen, May 26, 1981 |
| U.S. Pat. No. 3,931,942 | Alpert, Jan. 13, 1976 |
| U.S. Pat. No. 3,740,896 | Glass, et al. Jun. 26, 1973 |
| U.S. Pat. No. 3,789,540 | Convertine, et al. Feb. 5, 1974 |
| U.S. Pat. No. 3,936,053 | Goldfarb, et al. Feb. 3, 1976 |
| U.S. Pat. No. 4,174,587 | Morin, et al. Nov. 20, 1979 |
| U.S. Pat. No. 4,329,806 | Akiyama, et al. May 18, 1982 |
| U.S. Pat. No. 4,513,967 | Halford, et al. Apr. 30, 1985 |

### BRIEF SUMMARY

In the present invention of Air-propelled Vehicle, a reversible air motor is used as a source to propel the said Air-propelled Vehicle into either forward or reverse motion. In general, an air motor produces rotation of its shaft when compressed air is introduced into the said air motor's inlet orifice. A reversible air motor generally has two inlet orifices and is capable of producing rotation of its shaft both in the clockwise as well as counterclockwise directions, when compressed air is introduced into the respective inlet orifices of the said reversible air motor. In the present invention of the said Air-propelled Vehicle, the said Shaft of the Reversible Air Motor is mechanically attached with the Axle of the said Air-propelled Vehicle, therefore, any rotation of the said Shaft of the said Reversible Air Motor will cause the said Axle of the said Air-propelled Vehicle to rotate as well. As the said Wheels of the said Air-propelled Vehicle are mechanically attached to the said Axle of the said Air-propelled Vehicle, rotation of the said Axle of the said Air-propelled Vehicle will produce rotation of the said Wheels of the said Air-propelled Vehicle, thus causing the said Air-propelled Vehicle to move.

The current invention comprises of the following components that make up the said Air-propelled Vehicle:
1. A Fully Compressed Air Storage Tank, with an inlet orifice and an outlet orifice and the said Fully Compressed Air Storage Tank is used to store the Fully Compressed Air.
2. A Partially Compressed Air Holding Tank, with an inlet orifice and an outlet orifice and the said Partially Compressed Air Storage Tank is used to store the Partially Compressed Air.
3. An Air Compressor that compresses the said Partially Compressed Air into the said Fully Compressed Air.
4. Reversible Air Motor with two inlet orifices, referred to here as “Forward Inlet Orifice”, to rotate the shaft of the said Reversible Air Motor in one direction, assumed here to produce forward motion of the said Air-propelled Vehicle, when the said Fully Compressed Air is introduced into the said “Forward Inlet Orifice”, and a “Reverse Inlet Orifice” to rotate the said Shaft of the said Reversible Air Motor, in the opposite direction, assumed here to produce reverse motion of the said Air-propelled Vehicle, when the said Fully Compressed Air is introduced into the said “Reverse Inlet Orifice”. A “Discharge Orifice” to discharge the partially compressed air from the said Reversible Air Motor after the said Fully Compressed Air passes through the said Reversible Air Motor and becomes Partially Compressed Air.
5. A Discharge Valve that is a one-way valve, with an inlet orifice and an outlet orifice whereas the said inlet orifice of the said Discharge valve is mechanically attached to the said Discharge Orifice of the said Reversible Air Motor and the said Discharge Valve allows the said Partially Compressed Air to flow from the said Discharge Orifice of the said Reversible Air Motor into the said inlet orifice of the said Discharge valve and expels the said Partially Compressed Air out through the said outlet orifice of the said Discharge Valve.
6. Safety Valves mechanically attached to the said Fully Compressed Air Storage Tank and the said Partially Compressed Air Storage Tank, that allow the said Fully Compressed Air to escape from the said Fully Compressed Air Storage Tank and similarly allow the Partially Compressed Air to escape from the said Partially Compressed Air Storage Tank, in case the air pressure inside the said Fully Compressed Air Storage Tank or the said Partially Compressed Air Storage Tank exceeds their design limits.
7. A Forward Motion Air Control Mechanism with an inlet orifice and an outlet orifice and a control valve that is mechanically controlled by the movement of a lever, and the said lever opens the said control valve when the said lever is moved to the said lever's “Forward” position, and the said lever closes said control valve when the said lever is moved to the said lever's “OFF” position.
8. A Reverse Motion Air Control Mechanism that has an inlet orifice and an outlet orifice and a control valve that is mechanically controlled by the movement of a lever, and the said lever opens the said control valve when the said lever is moved to the said lever's “Reverse” position, and the said lever closes said control valve when the said lever is moved to the said lever's “OFF” position.
9. A hose that connects the said outlet orifice of the said Partially Compressed Air Holding Tank to the said inlet orifice of the said Air Compressor.
10. A hose that connects the said outlet orifice of the said Air Compressor to the said inlet orifice of the said Fully Compressed Air Storage Tank.
11. A Diverter that has one inlet orifice and that has its first outlet orifice and a second outlet orifice, and that diverts the Fully Compressed Air towards its said first outlet orifice and the said second outlet orifice.
12. A Main Hose that connects the said outlet orifice of the said Fully Compressed Air Storage Tank to the said inlet orifice of the said Diverter.
13. A Forward Hose that connects the said first outlet orifice of the said Diverter to the said inlet orifice of the said Forward Motion Air Control Mechanism.
14. A Reverse Hose that connects the said second outlet orifice of the said Diverter to the said inlet orifice of the said Reverse Motion Air Control Mechanism.
15. A hose that connects the said outlet orifice of the said Forward Motion Air Control Mechanism to the said Forward Inlet Orifice of the said Reversible Air Motor.
16. A hose that connects the said outlet orifice of the said Reverse Motion Air Control Mechanism to the said Reverse Inlet Orifice of the said Reversible Air Motor.
17. A Hose that connects the said outlet orifice of the said Discharge Valve to the said inlet orifice of the said Partially Compressed Air Holding Tank.
18. A hose that connects the said outlet orifice of the said Partially Compressed Air Holding Tank to the said inlet orifice of the said Air Compressor.
19. A hose that connects the said outlet orifice of the said Air Compressor to the said inlet orifice of the said Fully Compressed Air Holding Tank.
20. An axel on which there are mechanically attached wheels, so that when the said Axle rotates, the said Wheels of the said Air-propelled Vehicle would also rotate in the same direction as the direction of rotation of the said Axle, thus moving the said Air-propelled Vehicle in a direction depending on the direction of rotation of the said Axle.

Under normal conditions, the said Air-propelled Vehicle is not in motion, the said Compressed Air Storage Tank is filled with said Fully Compressed Air, the said Main Hose, the said Diverter, the said Forward Hose and the said Reverse Hose are all filled with the said Fully Compressed Air and the said lever of the said Forward Motion Control Mechanism and the said lever of the said Reverse Motion Control Mechanism are both in the “OFF” positions.

As soon as the said lever of the Forward Motion Air Control Mechanism is moved to “Forward” position, the said Fully Compressed Air present in the said Forward Hose will be released into the said Forward Inlet Orifice of the said Reversible Air Motor. The said Fully Compressed Air will enter into the said Reversible Air Motor and will cause the said Shaft of the said Reversible Air Motor to rotate. Since the said Shaft of said Reversible Air Motor is mechanically attached to the said Axle of the said Air-propelled Vehicle, the said Axle of the said Air-propelled Vehicle would also rotate in the same direction as the direction of rotation of the said Shaft of the said Reversible Air Motor. Also, since the said Wheels of the said Air-propelled Vehicle are mechanically connected to the said Axle of the said Air-propelled Vehicle, the said Wheels of the said Air-propelled Vehicle would also rotate in the same direction as the direction of rotation of the said Axle of the said Air-propelled Vehicle, thus moving the said Air-propelled Vehicle in the forward direction. As the said compressed air passes through the said Reversible Air Motor and produces the forward motion of the said Air-propelled Vehicle as explained above, it looses some of its pressure in the process and becomes Partially Compressed Air. The said Partially Compressed Air is then exhausted through the said Discharge Orifice of the said Reversible Air Motor.

The said Discharge Orifice of the said Reversible Air Motor is connected to the said inlet orifice of the said Partially Compressed Air Holding Tank via the said Discharge Hose. The said outlet orifice of the said Partially Compressed Air Holding Tank is connected to the said inlet orifice of the said Air Compressor via a hose. The said Air Compressor compresses the said Partially Compressed Air received from the said Partially Compressed Air Holding Tank, to a desired pressure and discharges this Fully Compressed Air via the said outlet orifice of the said Air Compressor into the said inlet orifice of the said Fully Compressed Air Storage Tank. The said Fully Compressed Air Storage Tank feeds the said Fully Compressed Air into the said Main Hose via Fully Compressed Air Storage Tank's outlet orifice.

The said Main Hose is connected to the said inlet orifice of the said Diverter at one end and the said outlet orifice of the said Fully Compressed Air Storage Tank, one of the said outlet orifices of the said Diverter is connected to the said inlet orifice of the Forward Motion Air Control Mechanism via a hose while the other said outlet orifice of the said Diverter is connected to Reverse Motion Air Control Mechanism via a hose. The said Fully Compressed Air present in the said Main Hose will therefore be diverted to two said outlet orifices of the said Diverter and to the said inlet orifices of the Forward Motion Air Control Mechanism and the said Reverse Motion Air Control Mechanism via their respective said hoses.

The said Forward Motion Air Control Mechanism is connected to the said Forward Inlet Orifice of the said Reversible Air Motor via a hose. When the said lever for the said Forward Motion Air Control Mechanism is moved to the position marked as “Forward”, the said Fully Compressed Air present at the said inlet orifice of the said Forward Motion Air Control Mechanism will be released into the said Forward Inlet Orifice of the said Reversible Air Motor. The said Fully Compressed Air will enter into the said Reversible Air Motor and will cause the said Shaft of the said Reversible Air Motor to rotate. Since the said Shaft of the said Reversible Air Motor is mechanically connected to the said Axle of the said Air-propelled Vehicle, the said Shaft of the said Reversible Air Motor will cause the said Axle of the said Air-propelled Vehicle to rotate in the same direction as well. Since the said Wheels of the said Air-propelled Vehicle are mechanically connected to the said Axle of the said Air-propelled Vehicle, the said Wheels of the said Air-propelled Vehicle will also rotate in the same direction as well and thus the said Air-propelled Vehicle will move in one direction assumed here to be the forward direction. The said Fully Compressed Air passes through the said Reversible Air Motor and after producing the forward motion of the said Air-propelled Vehicle as explained above, the said Fully Compressed Air looses some of its pressure in the process and becomes Partially Compressed Air. The said Partially Compressed Air is then discharged through the Discharge Orifice of the said Reversible Air Motor. The said Partially Compressed Air then enters the said Partially Compressed Air Holding Tank via a hose that is connected between the Discharge Orifice of the said Reversible Air Motor and the said inlet orifice of the said Partially Compressed Air Holding Tank.

The said Partially Compressed Air enters the said Air Compressor via the said inlet orifice of the said air Compressor and a hose that is connected between the said outlet orifice of the said Partially Compressed Air Holding Tank and the said inlet orifice of the said Air Compressor. The said Air Compressor compresses the said Partially Compressed Air thus received to a desired pressure and discharges this Fully Compressed Air via the said outlet orifice of the said Air Compressor into the said inlet orifice of the said Fully Compressed Air Storage Tank. The said Fully Compressed Air Storage Tank feeds the said Fully Compressed Air into the said Main Hose via Fully Compressed Air Storage Tank's outlet orifice.

The said Reverse Motion Air Control Mechanism is connected to the said Reverse Inlet Orifice of the said Reversible Air Motor via a hose. When the said lever for the said Reverse Motion Air Control Mechanism is moved to the position marked as “Reverse”, the said Fully Compressed Air present at the said inlet orifice of the said Reverse Motion Air Control Mechanism will be released into the said Reverse Inlet Orifice of the said Reversible Air Motor. The said Fully Compressed Air will enter into the said Reversible Air Motor and will cause the said Shaft of the said Reversible Air Motor to rotate. Since the said Shaft of the said Reversible Air Motor is mechanically connected to the said Axle of the said Air-propelled Vehicle, the said Shaft of the said Reversible Air Motor will cause the said Axle of the said Air-propelled Vehicle to rotate in the same direction as well. Since the said Wheels of the said Air-propelled Vehicle are mechanically connected to the said Axle of the said Air-propelled Vehicle, the said Wheels of the said Air-propelled Vehicle will also rotate in the same direction as well and thus the said Air-propelled Vehicle will move in a direction assumed here to be the reverse direction. The said Fully Compressed Air passes through the said Reversible Air Motor and after producing the reverse motion of the said Air-propelled Vehicle as explained above, the said Fully Compressed Air looses some of its pressure in the process and becomes Partially Compressed Air. The said Partially Compressed Air is then discharged through the Discharge Orifice of the said Reversible Air Motor. The said Partially Compressed Air then enters the said Partially Compressed Air Holding Tank via a hose that is connected between the Discharge Orifice of the said Reversible Air Motor and the said inlet orifice of the said Partially Compressed Air Holding Tank.

The said Partially Compressed Air enters the said Air Compressor via the said inlet orifice of the said Air Compressor and a hose that is connected between the said outlet orifice of the said Partially Compressed Air Holding Tank and the said inlet orifice of the said Air Compressor. The said Air Compressor compresses the said Partially Compressed Air received, to a desired pressure and discharges the resulting Fully Compressed Air via the said outlet orifice of the said Air Compressor into the said inlet orifice of the said Fully Compressed Air Storage Tank. The said Fully Compressed Air Storage Tank feeds the said Fully Compressed Air into the said Main Hose via Fully Compressed Air Storage Tank's outlet orifice.

### BRIEF DESCRIPTION OF THE DRAWING

The drawings comprise of schematic representation of the present invention of Air-propelled Vehicle, used in combination with a vehicle having wheels and a driving mechanism to make it maneuverable to be driven as a means of transportation to travel for a long or short distance, said vehicle comprising of the following components and systems as described in the following drawings:

FIG. 1: FIG. 1 shows a pictorial depiction of various components that make up this invention, and their possible physical installation location with respect to this invention of Air-propelled Vehicle. A Compressed Air Storage Tank 12 that is mechanically secured to the frame of the said Air-propelled Vehicle and that is used to store the Fully Compressed Air, having a Safety Device 66 to release the said Fully Compressed Air in case the pressure inside the said Compressed Air Storage Tank 12 rises above the designed limitations of the said Compressed Air Storage Tank 12, having an inlet orifice 38 to receive Fully Compressed Air via a hose 24 and having an outlet orifice 40 to discharge the said Fully Compressed Air; a hose 26 that is connected to the said outlet orifice 40 of the said Compressed Air Storage Tank 12 and that is connected to the inlet orifice 42 of a Diverter 18; a hose 28 that is connected to the Forward Orifice 46 of the said Diverter 18 at one end and that is connected to the inlet orifice 48 of the Forward Motion Air Control Mechanism 6 on the other end; a hose 30 that is connected to the Reverse Orifice 44 of the said Diverter 18 at one end and that is connected to the inlet orifice 50 of the Reverse Motion Air Control Mechanism 4 on the other end; a hose 32 that is connected to the outlet orifice 52 of the said Forward Motion Air Control Mechanism 6 at one end and that is connected to Orifice For Forward Motion 56 of the Reversible Air Motor 2 at the other end; a hose 34 that is connected to the outlet orifice 54 of the said Reverse Motion Air Control Mechanism 4 at one end and that is connected to Orifice For Reverse Motion 58 of the said Reversible Air Motor 2 at the other end; a Partially Compressed Air Holding Tank 10 that is used to hold the Partially Compressed Air having a safety device 22 to release the said Partially Compressed Air in case the pressure inside the said Partially Compressed Air Holding Tank 10 rises above the designed limitations of the said Partially Compressed Air Holding Tank 10, having an inlet orifice 20 to receive the Partially Compressed Air and an outlet orifice 62 to discharge the said Partially Compressed Air; a Discharge Valve 72 that is attached to the Discharge Orifice 60 of the said Reversible Air Motor 2; a Discharge Hose 36 that is connected to the Discharge Valve 72 and that is connected to the inlet orifice 20 of the said Partially Compressed Air Holding Tank 10; an Air Compressor 8 with an inlet orifice 64 and an outlet orifice 70 that compresses the Partially Compressed Air to a desirable pressure; a hose 14 that is connected between the said outlet orifice 62 of the said Partially Compressed Air Holding Tank 10 at one end and that is connected to the inlet orifice 64 of the said Air Compressor 8 at the other end; a hose 24 that is connected between the said outlet orifice 70 of the said Air Compressor 8 at one end and that is connected to the inlet orifice 38 of the said Compressed Air Storage Tank 12;

### DESCRIPTION OF THE DRAWING

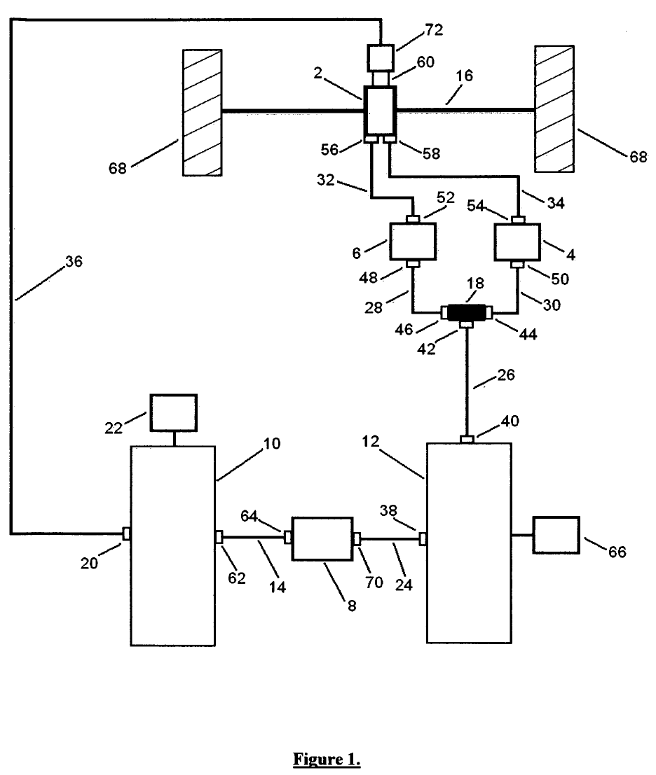

A complete understanding of the present invention may be obtained by reference to the FIG. 1 as the accompanying drawing, when considered in conjunction with the subsequent detailed description of FIG. 1.

### DETAILED DESCRIPTION OF THE DRAWING

FIG. 1: shows the said Air-propelled Vehicle of the present invention. Under normal conditions, the said Air-propelled Vehicle is stationary, and the said Compressed Air Storage Tank 12 is filled with Fully Compressed Air that is compressed to a predetermined pressure, the Forward Motion Air Control Mechanism 6 and the Reverse Motion Air Control Mechanism 4 are in the “OFF” position, and the said Main Hose 26 is filled with the Fully Compressed Air thus making the said Diverter 18, the said Forward Hose 28 and the said Reverse Hose 30 to be filled with Fully Compressed Air.

Forward Motion of the said Air-propelled Vehicle:

As soon as the said lever of the said Forward Motion Air Control Mechanism 6 is moved to the position marked as “Forward”, the said Fully Compressed Air present at the said inlet orifice 48 of the said Forward Motion Air Control Mechanism 6 will be released into the said Inlet Orifice For Forward Motion 56 of the said Reversible Air Motor 2 via said outlet orifice 52 of the said Forward Motion Air Control Mechanism 6 and said hose 32. The said Fully Compressed Air, as it enters into the said Reversible Air Motor 2, will cause the shaft of the said Reversible Air Motor 2, to rotate. Since the said Shaft of the said Reversible Air Motor 2 is mechanically connected to Axle 16 of the said Air-propelled Vehicle, the said Axle 16 of the said Air-propelled Vehicle will also rotate in the same direction as that of the said Shaft of the said Reversible Air Motor 2. In addition, the said Wheels 68 of the said Air-propelled Vehicle are mechanically attached to the said Axle 16 of the said Air-propelled Vehicle, therefore rotation of the said Axle 16 of the said Air-propelled Vehicle will cause the said Wheels 68 of the said Air-propelled Vehicle to rotate in the same direction as the direction of rotation of said Axle 16 of the said Air-propelled Vehicle and therefore will cause the said Air-propelled Vehicle to move in the forward direction.

As the said Fully Compressed Air passes through the said Reversible Air Motor 2 to produce the forward motion of the said Air-propelled Vehicle as explained above, the said Fully Compressed Air loses some of its pressure in the process and becomes Partially Compressed Air. The said Partially Compressed Air is then discharged through the said Discharge Orifice 60 of the said Reversible Air Motor 2 via a Discharge Valve 72. The said Discharge Valve 72 is a one-way pneumatic valve that allows the air to flow only in one direction. The said Discharge valve 72 is connected to the said inlet orifice 20 of the said Partially Compressed Air Holding Tank 10 via Discharge Hose 36 thus allowing the said Partially Compressed Air being discharged from the said Reversible Air Motor 2 to be stored in the said Partially Compressed Air Holding Tank 10. The said outlet orifice 62 of the said Partially Compressed Air Holding Tank 10 is connected to the said inlet orifice 64 of the said Air Compressor 8 via a hose 14 that allows the said Partially Compressed Air to pass from said Partially Compressed Air Holding Tank 10 via its outlet orifice 64 and the said Hose 14 into the said inlet orifice 64 of the said Air Compressor 8. The said Air Compressor 8 compresses the said Partially Compressed Air entering via its said orifice 64 to a desired pressure and discharges this Fully Compressed Air via the said outlet orifice 70 of the said Air Compressor 8 into the said inlet orifice 38 of the said Fully Compressed Air Storage Tank 12 via said Hose 24.

Reverse Motion of the said Air-propelled Vehicle:

Under normal conditions, the said Air-propelled Vehicle is stationary, and the said Compressed Air Storage Tank 12 is filled with Fully Compressed Air that is compressed to a predetermined pressure, the Forward Motion Air Control Mechanism 6 and the Reverse Motion Air Control Mechanism 4 are in the OFF position, and the said Main Hose 26 is filled with the Fully Compressed Air thus making the said Diverter 18, the said Forward Hose 28 and the said Reverse Hose 30 to be filled with Fully Compressed Air.

As soon as the said lever of the said Forward Motion Air Control Mechanism 6 is moved to the position marked as “Reverse”, the said Fully Compressed Air present at the said inlet orifice 50 of the said Reverse Motion Air Control Mechanism 4 will be released into the said Inlet Orifice For Reverse Motion 58 of the said Reversible Air Motor 2 via said outlet orifice 54 of the said Reverse Motion Air Control Mechanism 4 and said hose 34. The said Fully Compressed Air, as it enters into the said Reversible Air Motor 2, it will cause the said Shaft of the said Reversible Air Motor 2, to rotate. Since the said Shaft of the said Reversible Air Motor 2 is mechanically connected to the Axle 16 of the said Air-propelled Vehicle, the said Axle 16 of the said Air-propelled Vehicle will also rotate in the same direction as that of the said Shaft of the said Reversible Air Motor 2. In addition, the said Wheels 68 of the said Air-propelled Vehicle are mechanically attached to the said Axle 16 of the said Air-propelled Vehicle, therefore rotation of the said Axle 16 of the said Air-propelled Vehicle will cause the said Wheels 68 of the said Air-propelled Vehicle to rotate in the same direction as the direction of rotation of the said Axle 16 of the said Air-propelled Vehicle and therefore will cause the said Air-propelled Vehicle to move in the reverse direction.

As the said Fully Compressed Air passes through the said Reversible Air Motor 2 to produce the reverse motion of the said Air-propelled Vehicle as explained above, the said Fully Compressed Air loses some of its pressure in the process and becomes Partially Compressed Air. The said Partially Compressed Air is then discharged through the said Discharge Orifice 60 of the said Reversible Air Motor 2 via a Discharge Valve 72. The said Discharge Valve 72 is a one-way pneumatic valve that allows the air to flow only in one direction. The said Discharge valve 72 is connected to the said inlet orifice 20 of the said Partially Compressed Air Holding Tank 10 via Discharge Hose 36 thus allowing the said Partially Compressed Air being discharged from the said Reversible Air Motor 2 to be stored in the said Partially Compressed Air Holding Tank 10.

The said outlet orifice 62 of the said Partially Compressed Air Holding Tank 10 is connected to the said inlet orifice 64 of the said Air Compressor 8 via a hose 14 that allows the said Partially Compressed Air to pass from said Partially Compressed Air Holding Tank 10 via its outlet orifice 64 and the said Hose 14 into the said inlet orifice 64 of the said Air Compressor 8. The said Air Compressor 8 compresses the said Partially Compressed Air entering via its said orifice 64 to a desired pressure and discharges this Fully Compressed Air via the said outlet orifice 70 of the said Air Compressor 8 into the said inlet orifice 38 of the said Fully Compressed Air Storage Tank 12 via said Hose 24.

An Air-propelled Vehicle used in combination with and comprising of; A Compressed Air Storage Tank that is mechanically secured to the said Frame of the said Air-propelled Vehicle, and that the said Compressed Air Storage Tank is used to store Fully Compressed Air, having a safety device to release the said Fully Compressed Air in case the pressure inside the said Compressed Air Storage Tank rises above the designed limitations of the said Compressed Air Storage Tank, and having an inlet orifice to receive the said Fully Compressed Air from an Air Compressor, and having an outlet orifice to discharge the said Fully Compressed Air; A Diverter having an inlet orifice and two outlet orifices and that said Diverter diverts the said Fully Compressed Air into two paths through its said outlet orifices; a hose that is connected to the said outlet orifice of the said Compressed Air Storage Tank at one end and that is connected to the said inlet orifice of the said Diverter at the other end; a Forward Motion Air Control Mechanism that allows the said Fully Compressed Air to pass through when the control lever of the said Forward Motion Air Control Mechanism is moved to the “Forward” position and that stops to pass through the said Fully Compressed Air when the said control lever of the said Forward Motion Air Control Mechanism is moved to the “OFF” position, and the said Forward Motion Air Control Mechanism having an inlet orifice and the said Forward Motion Air Control Mechanism having an outlet orifice; a hose that is connected to the first said outlet orifice of the said Diverter at one end and that is connected to the said inlet orifice of the Forward Motion Air Control Mechanism on the other end; a Reverse Motion Air Control Mechanism that allows the said Fully Compressed Air to pass through when the control lever of the said Reverse Motion Air Control Mechanism is moved to the “Reverse” position and that stops the said Fully Compressed Air to pass through when the said control lever of the said Reverse Motion Air Control Mechanism is moved to the “OFF” position, and the said Reverse Motion Air Control Mechanism having an inlet orifice and the said Reverse Motion Air Control Mechanism having an outlet orifice; a hose that is connected to the second said outlet orifice of the said Diverter at one end and that is connected to the said inlet orifice of the said Reverse Motion Air Control Mechanism on the other end; Reversible Air Motor having a shaft, and that produces rotation of the said Shaft of the said Reversible Air Motor with the introduction of compressed air, and the said Reversible Air Motor having a Forward Motion Inlet Orifice, and the said Reversible Air Motor having a Reverse Motion Inlet Orifice and the said Reversible Air Motor having a common outlet orifice and that the direction of rotation of the said Shaft of the said Reversible Air Motor will depend on whether the said compressed air enters through its said Forward Motion Inlet Orifice or its said Reverse Motion Inlet Orifice; a hose that is connected to the said outlet orifice of the said Forward Motion Air Control Mechanism at one end and that is connected to the said Forward Motion Inlet Orifice of said Reversible Air Motor at the other end; a hose that is connected to the said outlet orifice of the said Reverse Motion Air Control Mechanism at one end and that is connected to the said Reverse Motion Inlet Orifice of the said Reversible Air Motor at the other end; a Partially Compressed Air Holding Tank that is used to hold partially compressed air and the said Partially Compressed Air Holding Tank having a safety device to release the said Partially Compressed Air in case the air pressure inside the said Partially Compressed Air Holding Tank rises above designed limitations of the said Partially Compressed Air Holding Tank, and the said Partially Compressed Air Holding Tank having an inlet orifice and the said Partially Compressed Air Holding Tank having an outlet orifice; a hose that is connected to the said outlet orifice of the said Reversible Air Motor at one end and that is connected to the said inlet orifice of the said Partially Compressed Air Holding Tank at the other end; an Air Compressor having and inlet orifice and an outlet orifice, and the said Air Compressor compresses the said Partially Compressed Air received through its said inlet orifice, to the desirable pressure; a hose that is connected between the said outlet orifice of the said Partially Compressed Air Holding Tank at one end and that is connected to the said inlet orifice of the said Air Compressor at the other end; a hose that is connected between the said outlet orifice of the said Air Compressor at one end and that is connected to the said inlet orifice of the said Fully Compressed Air Storage Tank at the other end.

1. An Air-propelled Vehicle comprising of:
a Reversible Air Motor having a shaft that is mechanically attached to the Axle of the said Air-propelled Vehicle and the said Axle of the said Air-propelled Vehicle is mechanically attached to the said Wheels of the said Air-propelled Vehicle, and on the introduction of Fully Compressed Air the said Inlet Orifice For Forward Motion of the said Reversible Air Motor, the said Reversible Air Motor is capable of rotating its shaft such that rotation of the said Shaft of the said Reversible Air Motor would cause the said Axle of the said Air-propelled Vehicle to rotate due to the mechanical attachment between the said Shaft of the said Reversible Air Motor and the said Axle of the said Air-propelled Vehicle, and the rotation of the said Axle of the said Air-propelled Vehicle would cause the said Wheels of the said Air-propelled Vehicle to rotate due to the said mechanical attachment between and the said Axle of the said Air-propelled Vehicle and the said Wheels of the said Air-propelled Vehicle so that the said Air-propelled Vehicle is propelled in a forward direction, the said Reversible Air Motor is capable of rotating its said shaft in the opposite direction such that rotation of the said Shaft of the said Reversible Air Motor would cause the said Axle of the said Air-propelled Vehicle to rotate in the opposite direction due to the said mechanical attachment between the said Shaft of the said Reversible Air Motor and the said Axle of the said Air-propelled Vehicle, and the rotation of the said Axle of the said Air-propelled Vehicle would cause the said Wheels of the said Air-propelled Vehicle to rotate in the opposite direction due to the mechanical attachment between and the said Axle of the said Air-propelled Vehicle and the said Wheels of the said Air-propelled Vehicle, so that the said Air-propelled Vehicle is propelled in a reverse direction, the said Reversible Air Motor having a common outlet orifice to exhaust the said Fully Compressed Air after the said Fully Compressed Air has passed through the said Reversible Air Motor and such said Fully Compressed Air now becomes Partially Compressed Air as a result of transferring its energy to rotate the said Shaft of the said Reversible Air Motor regardless the said Fully Compressed Air enters through the said Inlet Orifice For Forward Motion of the said Reversible Air Motor or the said Fully Compressed Air enters through the said Inlet Orifice For Reverse Motion of the said Reversible Air Motor;
an appropriate steering, braking, lighting and safety mechanism independent of the present invention, but required to operate the said Air-propelled Vehicle in a safe manner;
an Axle of the said Air-propelled Vehicle that is mechanically attached with the said Shaft of the said Reversible Air Motor so that the said Axle of the said Air-propelled Vehicle would rotate in the same direction as the direction of rotation of the said Shaft of the said Reversible Air Motor;
a set of wheels that are mounted on the said two ends of the said Axle of the said Air-propelled Vehicle, that are mechanically attached with the said Axle of the said Air-propelled Vehicle so that the said Wheels of the said Air-propelled Vehicle would rotate in the same direction of rotation as the direction of rotation of the said Axle of the said Air-propelled Vehicle;
a Fully Compressed Air Storage Tank that is secured to the frame of the said Air-propelled Vehicle, and the said Fully Compressed Air Storage Tank having an inlet orifice and an outlet orifice, and that is used to store Fully Compressed Air, and that is equipped with a safety device to release the said Fully Compressed Air in case the air pressure of the said Fully Compressed Air inside the said Fully Compressed Air Storage Tank rises above the designed limitations of the said Fully Compressed Air Storage Tank, and that the said Fully Compressed Air is received through the said inlet orifice of the said Fully Compressed Air Storage Tank, and that the said Fully Compressed Air is discharged through the said outlet orifice of the said Fully Compressed Air Storage Tank;
an Air Compressor having an inlet orifice and an outlet orifice, and that receives the said Partially Compressed Air from the said Partially Compressed Air Holding Tank, via the said inlet orifice of the said Air Compressor, and the said Air Compressor compresses the said Partially Compressed Air to a desirable pressure so that the said Partially Compressed Air becomes Fully Compressed Air and the said Fully Compressed Air is then discharged through the said outlet orifice of the said Air compressor;
a Partially Compressed Air Holding Tank that is secured to the frame of the said Air-propelled Vehicle and the said Partially Compressed Air Storage Tank having an inlet orifice and an outlet orifice, and that is used to store Partially Compressed Air, and that is equipped with a safety device to release the said Partially Compressed Air in case the air pressure of the said Partially Compressed Air inside the said Partially Compressed Air Storage Tank rises above the designed limitations of the said Partially Compressed Air Storage Tank, and that the said Partially Compressed Air is received through the said inlet orifice of the said Partially Compressed Air Storage Tank, and that the said Partially Compressed Air is discharged through the said outlet orifice of the said Partially Compressed Air Storage Tank;
a Forward Motion Air Control Mechanism having an inlet orifice and an outlet orifice and having a control lever that controls the amount of the said Fully Compressed Air that enters through the said inlet orifice of the said Forward Motion Air Control Mechanism and exits through the said outlet orifice of the said Forward Motion Air Control Mechanism;
a Reverse Motion Air Control Mechanism having an inlet orifice and an outlet orifice and having a control lever the said Reverse Motion Air Control Mechanism controls the amount of the said Fully Compressed Air that enters through the said inlet orifice of the said Reverse Motion Air Control Mechanism and exits through the said outlet orifice of the said Reverse Motion Air Control Mechanism;
a Diverter having an inlet orifice and two outlet orifices and the said Diverter diverts the said Fully Compressed Air received through its said inlet orifice to the two said outlet orifices;
a hose that is connected to the said outlet orifice of the Fully Compressed Air Storage Tank at one end and that is connected to the inlet orifice of the said Diverter on the other;
a hose that is connected to the said first outlet orifice of the said Diverter at one end and that is connected to the said inlet orifice of the said Forward Motion Air Control Mechanism on the other end;
a hose that is connected to the said second outlet orifice of the said Diverter at one end and that is connected to the said inlet orifice of the Reverse Motion Air Control Mechanism on the other end;
a hose that is connected to the said outlet orifice of the said Forward Motion Air Control Mechanism at one end and that is connected to the said Inlet Orifice For Forward Motion of the said Reversible Air Motor at the other end;
a hose that is connected to the said outlet orifice of the said Reverse Motion Air Control Mechanism at one end and that is connected to the said Inlet Orifice for Reverse Motion of the said Reversible Air Motor at the other end;
a hose that is connected to the said outlet orifice of the said Reversible Air Motor at one end and that is connected to the said inlet orifice of the said Partially Compressed Air Holding Tank at the other end;
a hose that is connected between the said outlet orifice of the said Partially Compressed Air Holding Tank at one end and that is connected to the said inlet orifice of the said Air Compressor on the other end;
a hose that is connected to the said outlet orifice of the said Air Compressor at one end and that is connected to the said inlet orifice of the said Fully Compressed Air Storage Tank on the other end;

2. The Air-propelled Vehicle of claim 1 wherein: the said Air Compressor is not used, instead, the said Fully Compressed Air Tank is externally filled with the said Fully Compressed Air;

3. The Air-propelled Vehicle of claim 1 wherein: the said Partially Compressed Air Tank is not used, instead, the said Air Compressor having an inlet orifice and an outlet orifice, takes in the atmospheric air through the said inlet orifice of the said Air Compressor, compresses it to a desirable pressure and discharges it through the said out orifice of the said Air Compressor;

4. The Air-propelled Vehicle of claim 1 wherein: the said Discharge Valve is not used;

5. The Air-propelled Vehicle of claim 1 wherein: the said Air Compressor having an inlet orifice and an outlet orifice, and the said Air Compressor is powered by a combustion type engine running on fossil fuel;

6. The Air-propelled Vehicle of claim 1 wherein: the said Air Compressor having an inlet orifice and an outlet orifice, and the said Air Compressor is powered by means of an electrical motor that runs on stored or produced electrical energy;

7. The Air-propelled Vehicle of claim 1 wherein: the said Air Compressor having an inlet orifice and an outlet orifice, and the said Air Compressor is powered by means of a combination of a combustion engine running on fossil fuel and an electrical motor;

8. The Air-propelled Vehicle of claim 1 wherein: instead of the said Reversible Air Motor, separate unidirectional air motors are used that produce rotation in opposite directions;

9. The Air-propelled Vehicle of claim 1 wherein: the said Air Compressor having and inlet orifices and an outlet orifice, that is equipped to receive the said Partially Compressed Air through one of the inlet orifices and that is equipped to receive the atmospheric air through the other inlet orifice and that compresses the mixture of said Partially Compressed Air and the said atmospheric air to a desired pressure so that the said mixture is compressed to become the said Fully Compressed Air;

10. The Air-propelled Vehicle of claim 1 wherein: instead of using a separate said Forward Motion Air Control Mechanism and a separate said Reverse Motion Air Control Mechanism, a dual-function air control mechanism is used to function as both as the said Forward Motion Air Control Mechanism and the said Reverse Motion Air Control Mechanism;

11. The Air-propelled Vehicle of claim 1 wherein; the said dual-function air control mechanism, if used in lieu of the said Forward Motion Air Control Mechanism and the said Reverse Motion Air Control Mechanism, is electronically controlled and operated;

12. The Air-propelled Vehicle of claim 1 wherein; the said Forward Motion Air Control Mechanism, the said Reverse Motion Air Control Mechanism are electronically controlled and operated;

13. The Air-propelled Vehicle of claim 1 wherein; said Shaft of the said Reversible Air Motor is attached to the said Axle of the said Air-propelled Vehicle through a mechanical transmission mechanism instead of a direct mechanical attachment in order to transmit rotation of the said Shaft of the said Reversible Air Motor to the said Axle of the said Air-propelled Vehicle;

14. The Air-propelled Vehicle of claim 1 wherein; more than one said Reversible Air Motors are used instead of a single Reversible Air Motor;

15. The Air-propelled Vehicle of claim 1 wherein; air motors are used in any shape, form, configuration, quantity and location within the confinement of the said Air-propelled Vehicle, so that the said air motors are the source of primary or secondary propulsion power for the said Air-propelled Vehicle;
